(19) United States
(12) Patent Application Publication
(10) Pub. No.: US 2019/0201917 A1
(43) Pub. Date: Jul. 4, 2019

(54) MULTI-PURPOSE CONNECTOR FOR SPRINKLER

(71) Applicant: SEUNGJIN IND. CO., LTD, Gyeonggi-do (KR)

(72) Inventor: Woon Taek Jung, Gyeonggi-do (KR)

(73) Assignee: SEUNGJIN IND. CO., LTD, Gyeonggi-do (KR)

(21) Appl. No.: 15/974,156

(22) Filed: May 8, 2018

(30) Foreign Application Priority Data
Dec. 28, 2017 (KR) 10-2017-0182390

(51) Int. Cl. B05B 1/00; F16K 1/14; F16K 31/60

(52) U.S. Cl. CPC B05B 1/00; F16K 31/60; F16K 1/14

(57) ABSTRACT

A multi-purpose connector for a sprinkler. Fastening portions are provided on both ends of a body. A shutoff valve is disposed within the body. An adjustment member disposed outside of the body to control the shutoff valve. The multi-purpose connector directly or indirectly connects a sprinkler head to a sprinkler pipe. The connector is used to connect a sprinkler head and a sprinkler pipe and provides convenience due to an opening/closing function thereof.

### CROSS REFERENCE TO RELATED APPLICATION(S)

This application claims the benefit of Korean Patent Application No. 10-2017-0182390, filed on Dec. 28, 2017, which is hereby incorporated by reference in its entirety into this application.

### BACKGROUND OF THE INVENTION

### Field of the Invention

The present invention relates generally to a sprinkler and, more particularly, to a multi-purpose connector for a sprinkler, the connector being usable to connect a sprinkler head and a sprinkler pipe and able to provide convenience due to an opening/closing function thereof.

### Description of the Related Art

High-rise buildings and large buildings are required to be provided with a variety of fire suppression systems, since a fire on such buildings may lead to a large disaster. A representative example of such fire suppression systems is a sprinkler system. Sprinkler systems are also used in other types of buildings, such as apartments, houses, and commercial buildings, and are regarded as most effective means for suppressing fire at an early stage of fire.

In each of sprinkler systems, when a rise in temperature caused by flame is detected, a heat-sensitive portion of the sprinkler system is melted or exploded by heat, so that water constantly pressurized in the pipe is discharged to suppress fire.

FIG. 1 is a perspective view illustrating a fixing structure of a sprinkler head, which is typically in use.

As illustrated in FIG. 1, a sprinkler head 1 is fixedly disposed on the ceiling via an angled frame structure 4, a bracket 5, and a coupling member 2. The angled frame structure is disposed within the ceiling, and is connected to the bracket 5 by being fitted into a receptacle 8 through an opening 7. The coupling member 2 is fitted into the bracket 5, which is then tightened using a butterfly bolt 6, such that one portion of the coupling member 2 is connected to a fire suppression water line 3, and the other portion of the coupling member 2 is screw-engaged with the sprinkler head 1.

Another example of the connection of a sprinkler head is appreciated from FIGS. 2 and 3.

Referring to FIGS. 2 and 3, the sprinkler head 10 is fixed to the ceiling via a mounting member 20 and a coupling member 30. The mounting member 20 has a left-handed screw hole 22 in a central portion of a cylindrical disk 21 and a plurality of fixing protrusions 24 on the bottom surface of a flange 23. The coupling member 30 has a left-handed thread 31 in the outer circumference and a right-handed thread hole in the inner circumference. The left-handed thread 31 is screw-engaged into the left-handed screw hole 22, and the sprinkler head 10 is screw-engaged into the right-handed thread hole. The coupling member 30 is connected to a corrugated pipe 40 for a sprinkler.

In construction of a sprinkler system, the head exposed from the ceiling may be replaced as required. In a sprinkler system of the related art, water must be discharged from the entirety of sprinkler pipes when the sprinkler head is replaced or in an examination or maintenance. This is inconvenient and wastes water, which is problematic.

### SUMMARY OF THE INVENTION

Accordingly, the present invention has been made keeping in mind the above problems occurring in the related art, and the present invention is intended to propose a multi-purpose connector for a sprinkler that can be selectively used, depending on site conditions, to connect a sprinkler head to a sprinkler pipe. When the sprinkler head is to be replaced or for examination, the connector can be selectively opened or closed to prevent water from being discharged from sprinkler pipes.

In order to achieve the above object, according to one aspect of the present invention, a multi-purpose connector for a sprinkler may include: a body; fastening portions provided on both ends of the body; a shutoff valve disposed within the body; and an adjustment member disposed outside of the body to control the shutoff valve, whereby a sprinkler head is directly or indirectly connectable to a sprinkler pipe.

The shutoff valve may be rotated in response to the adjustment member being turned, thereby opening or closing a fluid passage.

The fastening portions may be male threads provided on the both ends of the body.

The fastening portions may be a male thread provided on one end of the both ends of the body and a female thread provided on the other end of the both ends of the body.

A portion of the body, including the female thread of the fastening portions, may be a reducer to which the sprinkler head is directly coupled.

A first male thread of the male threads may be connected to the sprinkler pipe, a reducer may be connected to a second male thread of the male threads, and the sprinkler head may be connected to the reducer.

The shutoff valve may be a ball valve or a butterfly valve.

The adjustment member may be a lever connected to and protruding from a stem of the shutoff valve.

The adjustment member may be connected to a stem of the shutoff valve, and may have a jig groove, thereby allowing the adjustment member be manipulated using a jig.

The shutoff valve may be completely opened when the lever is aligned with a centerline of the body and may be completely closed when the lever is at right angles with respect to the centerline of the body.

The lever may be coated with a luminous material.

According to another aspect of the present invention, a multi-purpose connector module for a sprinkler may include: a multi-purpose connector including a body, fastening portions provided on both ends of the body, a shutoff valve disposed within the body, and an adjustment member disposed outside of the body to control the shutoff valve; a sprinkler head connected to the fastening portion on one end of the both ends of the body; a flexible sprinkler pipe, with a bottom end thereof being connected to the fastening portion on the other end of the both ends of the body using a slip nut; and a nipple connected to and branched from a fire suppression branch pipe, wherein a top end of the flexible sprinkler pipe is connected to the nipple using a slip nut.

The multi-purpose connector for a sprinkler according to the present invention connects a sprinkler head to a sprinkler pipe, so that water can be supplied to the sprinkler head. Depending on situations, such as a maintenance, replacement, or examination, the multi-purpose connector can prevent water from being supplied to the sprinkler head, thereby preventing waste of water, so that an operation can be performed without discharging water from the entirety of sprinkler pipes.

In addition, the present invention is particularly available when the height of a sprinkler to be disposed must be adjusted depending on the height of a ceiling.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a perspective view illustrating a fixing structure of a sprinkler head, which is typically in use;

FIG. 2 is a perspective view illustrating a sprinkler head mounting device of the related art;

FIG. 3 is a side-elevation view of the mounting device illustrated in FIG. 2;

FIG. 4 is a perspective view illustrating a multi-purpose connector for a sprinkler according to a first embodiment of the present invention;

FIG. 5 is a cross-sectional view of FIG. 4;

FIG. 6 is a perspective view illustrating a multi-purpose connector for a sprinkler according to a second embodiment of the present invention;

FIG. 7 is a cross-sectional view of FIG. 6;

FIG. 8 is a perspective view illustrating a multi-purpose connector for a sprinkler according to a third embodiment of the present invention;

FIG. 9 is a cross-sectional view of FIG. 8;

FIG. 10 is a perspective view illustrating a multi-purpose connector for a sprinkler according to a fourth embodiment of the present invention;

FIG. 11 is a cross-sectional view of FIG. 10;

FIG. 12 illustrates an application in which, in the fastening portions on both ends of the body, one fastening portion is a male thread, and the other fastening portion is a female thread;

FIG. 13 illustrates an application in which both the fastening portions on both ends of the body are male threads;

FIG. 14 illustrates an application in which the adjustment member is implemented as jig groove; and

FIGS. 15A-15D illustrate a variety of applications of the multi-purpose connector for a sprinkler according to the present invention.

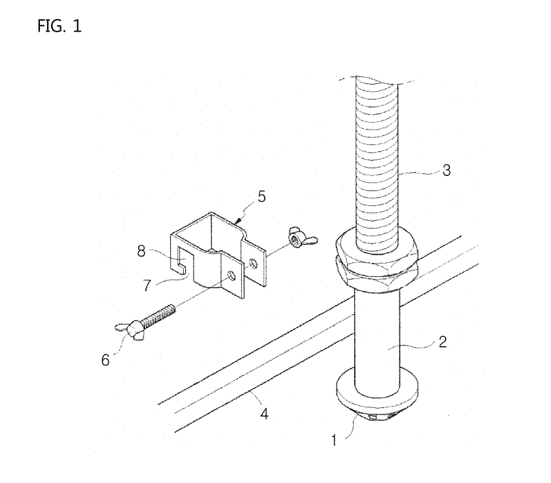

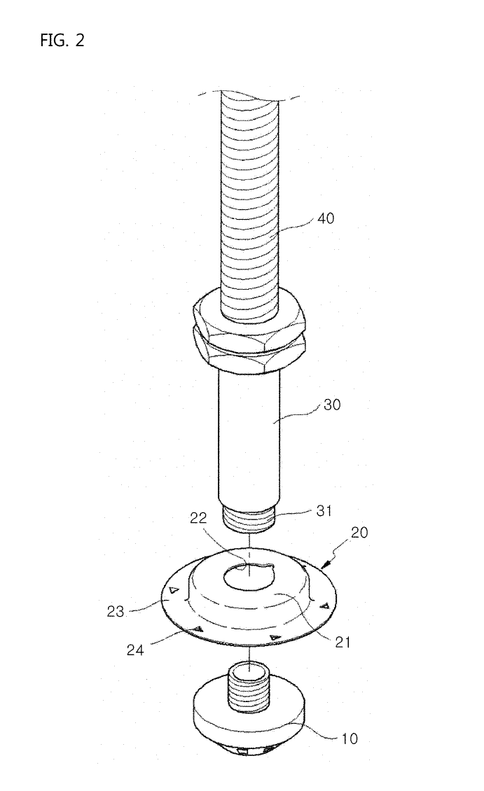

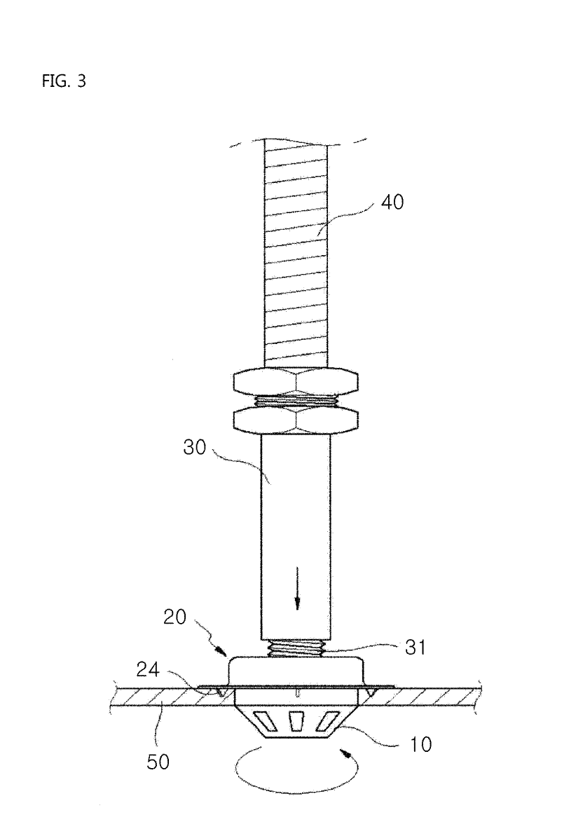

### DETAILED DESCRIPTION OF THE INVENTION

Hereinafter, exemplary embodiments of a multi-purpose connector for a sprinkler according to the present invention will be described in more detail with reference to the accompanying drawings for a better understanding of the concept of the present invention.

Since the drawings and exemplary embodiments to be described hereinafter are merely provided to illustrate examples that can be embodied according to the concept of the present invention, it should be understood that the scope of the present invention is by no means limited thereby.

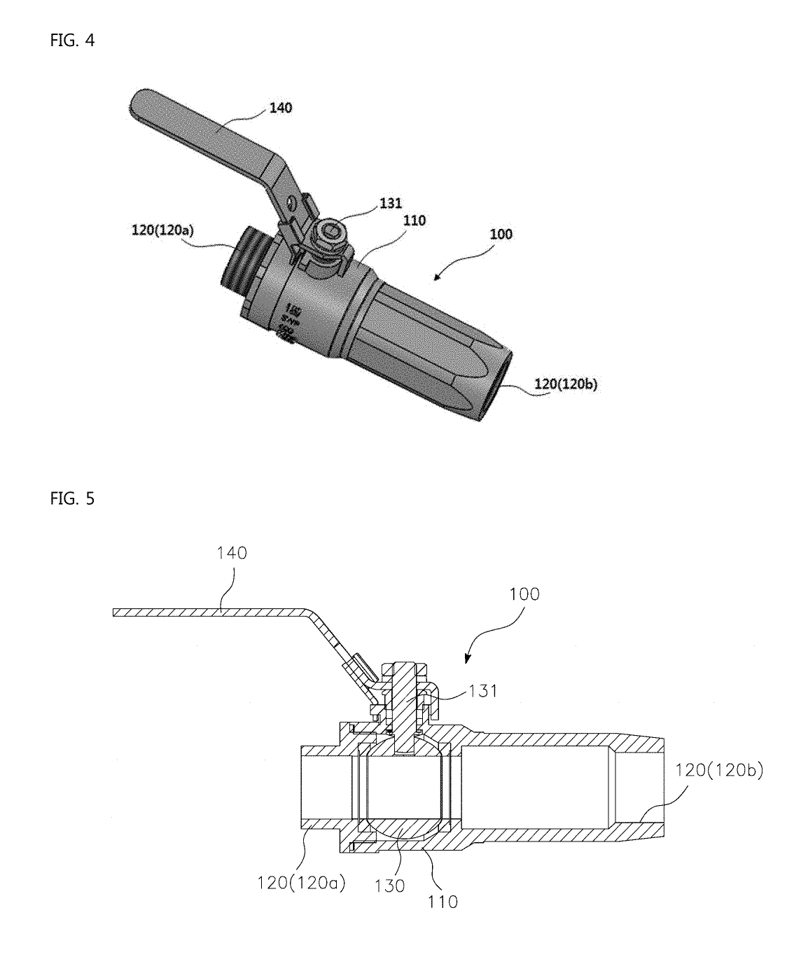

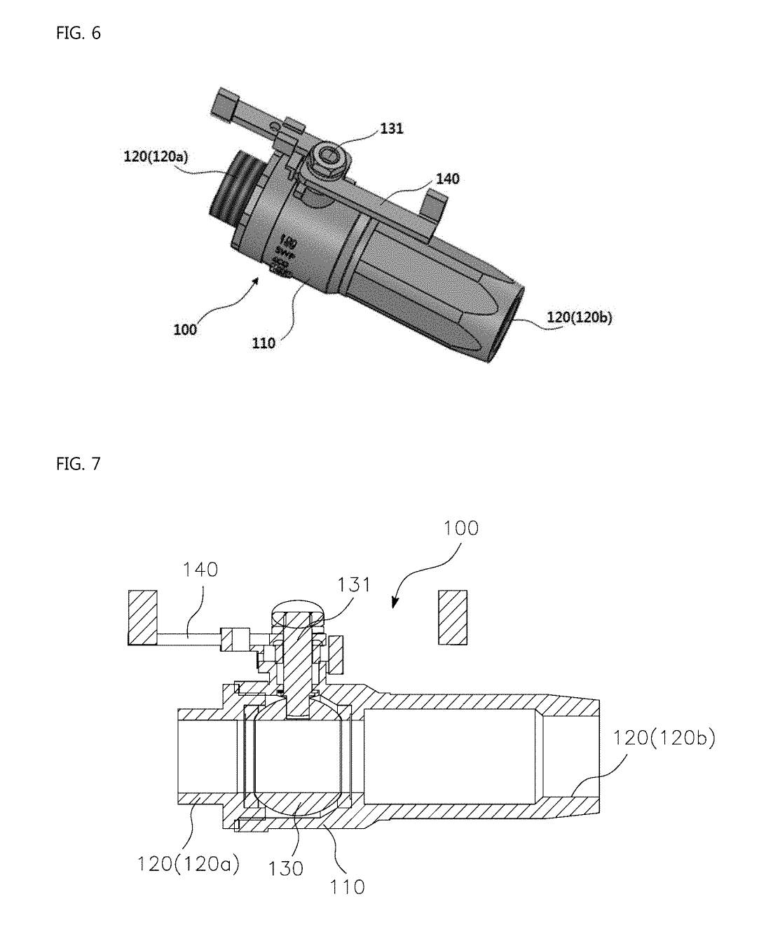

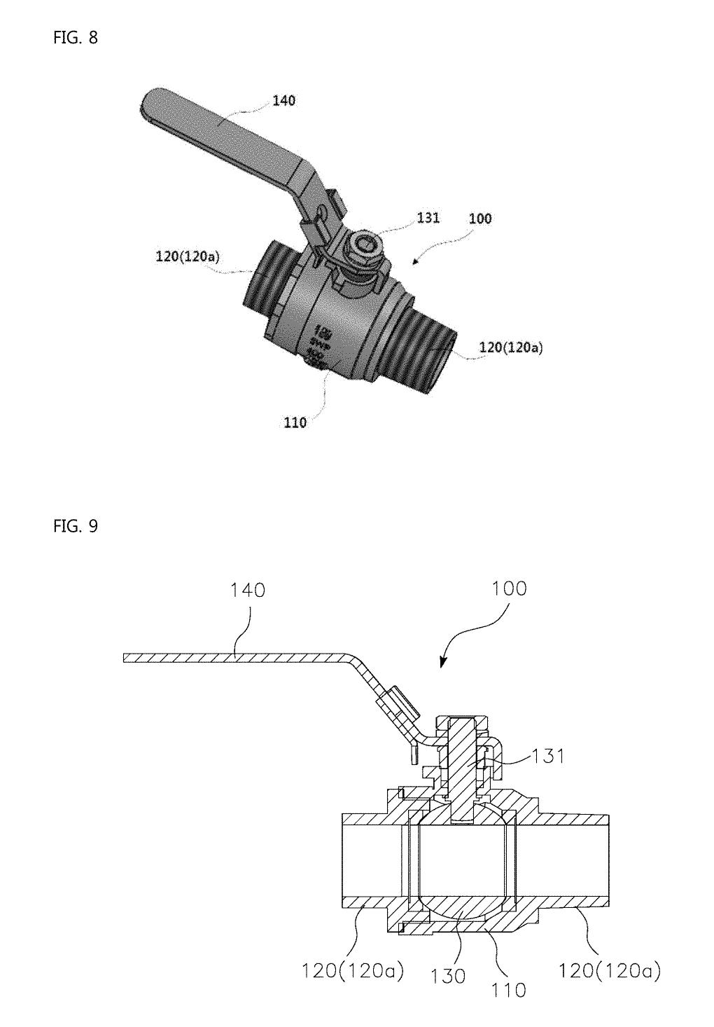

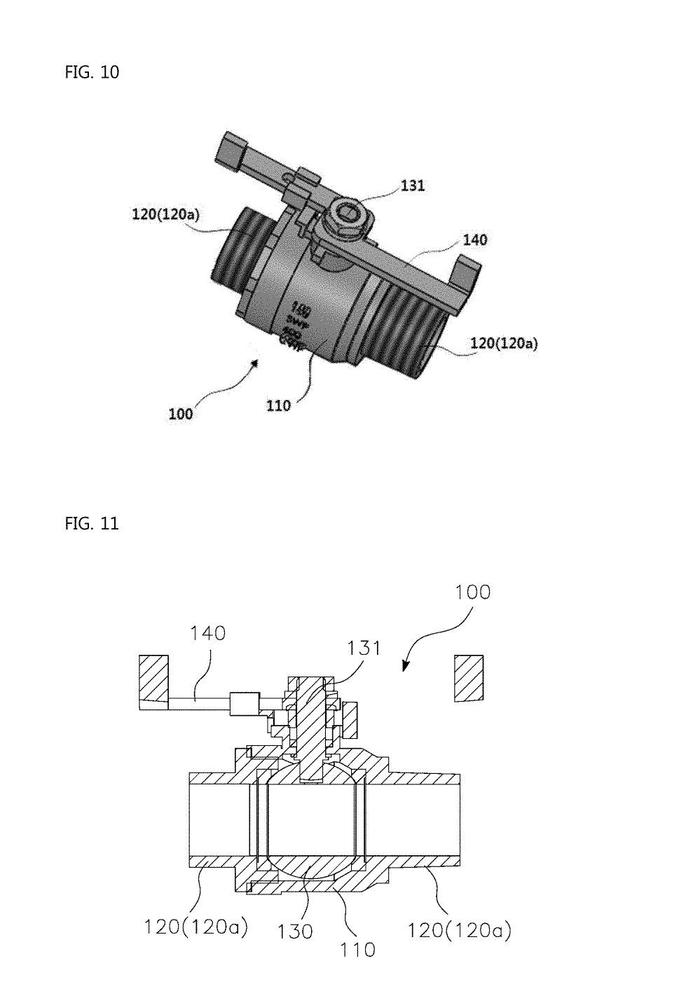

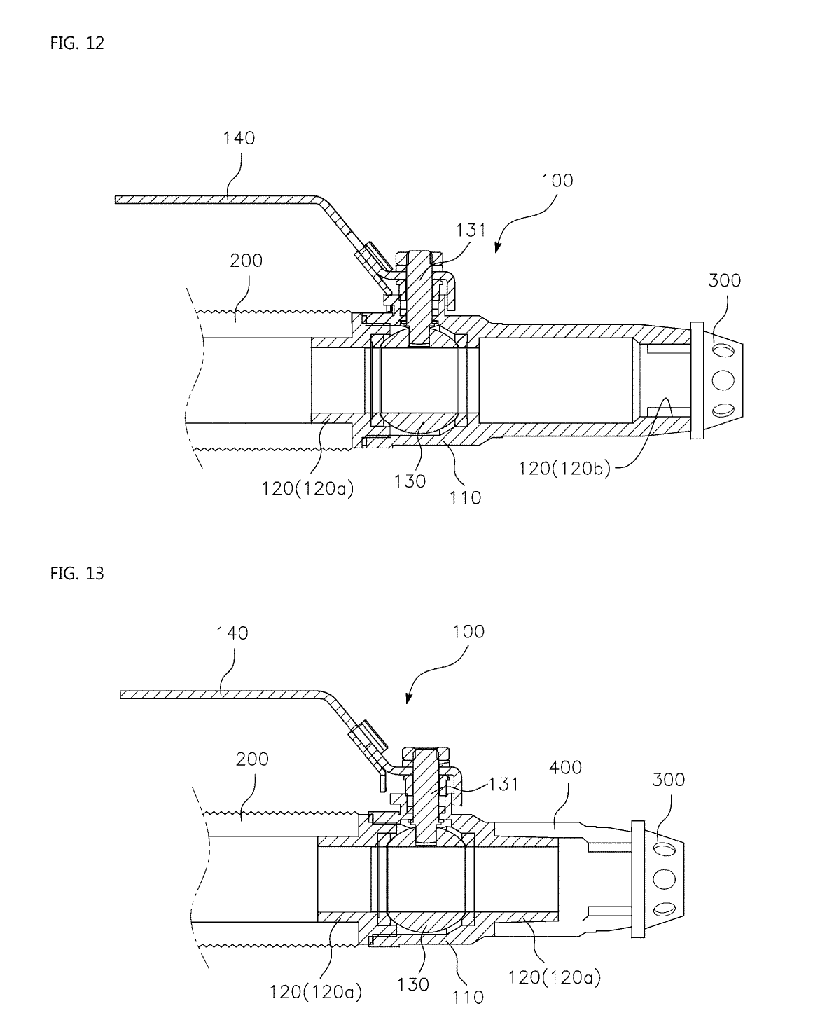

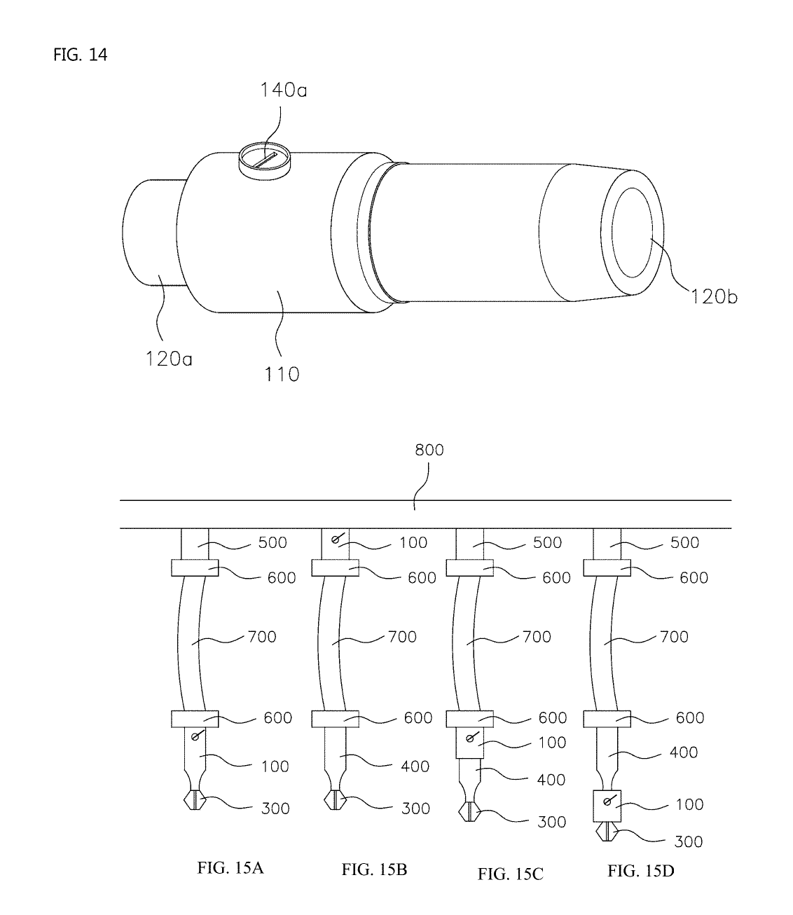

FIG. 4 is a perspective view illustrating a multi-purpose connector for a sprinkler according to a first embodiment of the present invention, FIG. 5 is a cross-sectional view of FIG. 4, FIG. 6 is a perspective view illustrating a multi-purpose connector for a sprinkler according to a second embodiment of the present invention, FIG. 7 is a cross-sectional view of FIG. 6, FIG. 8 is a perspective view illustrating a multi-purpose connector for a sprinkler according to a third embodiment of the present invention, FIG. 9 is a cross-sectional view of FIG. 8, and FIG. 10 is a perspective view illustrating a multi-purpose connector for a sprinkler according to a fourth embodiment of the present invention, FIG. 11 is a cross-sectional view of FIG. 10. In addition, FIG. 12 illustrates an application in which, in the fastening portions on both ends of the body, one fastening portion is a male thread, and the other fastening portion is a female thread, FIG. 13 illustrates an application in which both the fastening portions on both ends of the body are male threads, FIG. 14 illustrates an application in which the adjustment member is implemented as jig groove, and FIGS. 15A-15D illustrate a variety of applications of the multi-purpose connector for a sprinkler according to the present invention.

As illustrated in FIGS. 4 to 15A-15D, a multi-purpose connector 100 for a sprinkler according to the present invention is used to directly or indirectly connect a sprinkler head 300 to a sprinkler pipe 200. The multi-purpose connector 100 has a body 110 and fastening portions 120 on both ends of the body 110. A shutoff valve 130 is disposed within the body 110, while an adjustment member 140 is provided outside of the body 110 to control the shutoff valve 130.

In addition, the shutoff valve 130, disposed within the body 110, rotates in response to the adjustment member 140 being turned to open or close a fluid passage.

The fastening portions 120, disposed on both ends of the body 110, may be male threads 120a, as illustrated in FIGS. 8 to 11. As illustrated in FIGS. 4 to 7, the fastening portions 120 may be configured such that a male thread 120a is provided on one end of the body 110 and a female thread 120b is provided on the other end of the body 110.

In one case in which the fastening portions 120 are implemented as the male threads 120a provided on both ends of the body 110, as illustrated in FIGS. 8 to 11, the first male thread 120a on one end of the body 110 may be connected to the sprinkler pipe 200 and the second male thread 120a on the other end of the body 110 may be connected to a separate reducer 400, to which the sprinkler head 300 is connected, as illustrated in FIG. 13.

Here, the length of the reducer 400 can be suitably selected depending on site conditions, such that the sprinkler head 300 can be disposed at an optimum position, thereby improving workability.

In another case in which the fastening portion 120, provided on one end of the body 110, is implemented as the female thread 120b, as illustrated in FIG. 12, a portion of the body 110, including the female thread 120b, can act as a reducer, such that the sprinkler head 300 can be directly coupled to the end of the reducer.

In addition, the shutoff valve 130, disposed within the body 110, may be implemented as a ball valve or a butterfly valve, or may be selectively implemented as any other valve known in the art. The shutoff valve 130 may be implemented as any valve having any shape or name, which can rotate as manipulated so as to control the flow of fluid.

The shutoff valve 130 is connected to the adjustment member 140 disposed to be exposed externally from the body 110. The adjustment member 140 may be connected to a stem 131 coupled to the top end of the shutoff valve 130. The adjustment member 140 may be implemented as a lever 140 having a predetermined length.

The lever 140 may have the shape of a bar having a predetermined length, with one end thereof being connected to the stem 131. When a user pushes or pulls the lever 140 by applying force thereto, the stem 131 connected to the lever 140 is rotated, so that the shutoff valve 130 rotates.

According to another configuration, the adjustment member 140 may be connected to the stem 131 of the shutoff valve 130. As illustrated in FIG. 14, the adjustment member 140 may be implemented as a jig groove 140a provided in the top end of the stem 131, such that the adjustment member 140 can be manipulated using a jig.

The adjustment member 140 may be manipulated using a jig fitted into the jig groove 140a having the shape of a slot or a cross-hole, provided in the top end of the stem 131, so that the shutoff valve 130 is rotated to open or close the fluid passage.

The shutoff valve 130 may be configured such that the shutoff valve 130 is completely opened when the lever 140 is aligned with the centerline of the body 110 and is completely closed when the lever 140 is at right angles with respect to the centerline of the body 110.

It may be possible to intuitively determine whether the fluid passage is opened or closed, based on the position of the lever 140.

In addition, the surface of the lever 140 may be coated with a luminous material. The luminous material covering the lever 140 allows a worker to easily recognize the presence of the lever to manipulate the lever 140 in the night or when light is insufficient.

The sprinkler pipe may be a flexible pipe or a hard pipe. When the sprinkler head is connected to the sprinkler pipe using the multi-purpose connector for a sprinkler according to the present invention, a length-adjusting component, such as a nipple, known in the art, can be used.

Hereinafter, a more specific application of the multi-purpose connector for a sprinkler according to the present invention will be described with reference to FIGS. 15A-15D. That is, a multi-purpose connector module for a sprinkler, including the foregoing multi-purpose connector for a sprinkler, is proposed according to another aspect of the present invention.

The multi-purpose connector module for a sprinkler may include a multi-purpose connector 100 for a sprinkler, a sprinkler head 300, a flexible sprinkler pipe 700, a slip nut 600, a nipple 500, a reducer 400, and the like. The multi-purpose connector module may be connected to a fire suppression branch pipe 800 so as to be branched therefrom.

As illustrated in FIGS. 15A-15D, the multi-purpose connector module for a sprinkler may be connected to the fire suppression branch pipe 800, at a predetermined distance therefrom.

As illustrated in FIGS. 15A-15D, the multi-purpose connector module for a sprinkler according to the present invention can be constructed using a variety of combinations comprised of the foregoing components, depending on site conditions.

Hereinafter, a variety of applications of the multi-purpose connector module for a sprinkler according to the present invention will be described with reference to FIGS. 15A-15D.

The flexible sprinkler pipe 700 is connected to and branched from the fire suppression branch pipe 800 disposed on the ceiling, such that the sprinkler head 300 can be connected to the fire suppression branch pipe 800. Referring to part (a) in FIGS. 15A-15D, a nipple 500 is connected to the fire suppression branch pipe 800, and the top end of the flexible sprinkler pipe 700 is connected to the nipple 500 using a slip nut 600. The top end of the multi-purpose connector 100 for a sprinkler according to the present invention is connected to the bottom end of the flexible sprinkler pipe 700 using the slip nut 600, such that the sprinkler head 300 can be coupled to the bottom end of the multi-purpose connector 100 for a sprinkler.

Referring to FIG. 15B, one end of the multi-purpose connector 100 for a sprinkler according to the present invention is directly coupled to the fire suppression branch pipe 800, and the top end of the flexible sprinkler pipe 700 is connected to the other end of the multi-purpose connector 100 for a sprinkler using the slip nut 600. In addition, the reducer 400 is connected to the bottom end of the flexible sprinkler pipe 700 using the slip nut 600, with the sprinkler head 300 being connected to the reducer 400.

Referring to FIG. 15C, after the nipple 500 is connected to the fire suppression branch pipe 800, the top end of the flexible sprinkler pipe 700 is connected to the nipple 500 using the slip nut 600. One end of the multi-purpose connector 100 for a sprinkler according to the present invention is connected to the bottom end of the flexible sprinkler pipe 700 using the slit nut 600, and the reducer 400 is connected to the other end of the multi-purpose connector 100 for a sprinkler. In this position, the sprinkler head 300 is connected to the bottom end of the reducer 400.

In addition, referring to FIG. 15D, a construction may be undertaken as follows: after the nipple 500 is connected to the fire suppression branch pipe 800, the top end of the flexible sprinkler pipe 700 is connected to the nipple 500. After one end of the reducer 400 is connected to the bottom end of the flexible sprinkler pipe 700 using the slip nut 600, the multi-purpose connector 100 for a sprinkler according to the present invention is connected to the other end of the reducer 400. In this position, the sprinkler head 30 is connected to the multi-purpose connector 100 for a sprinkler.

As set forth above, the multi-purpose connector for a sprinkler according to the present invention can be used in a variety of shapes, can be directly coupled to a sprinkler head or a fire suppression branch pipe, and can be used to connect flexible sprinkler pipes. Accordingly, the multi-purpose connector for a sprinkler can be selectively used depending on site conditions.

The present invention can be used to construct a sprinkler system that suppresses fire in an event of fire or be used to replace an existing sprinkler system.

What is claimed is:

1. A multi-purpose connector for a sprinkler, comprising:
a body;
fastening portions provided on both ends of the body;
a shutoff valve disposed within the body; and
an adjustment member disposed outside of the body to control the shutoff valve,
whereby a sprinkler head is directly or indirectly connectable to a sprinkler pipe.

2. The multi-purpose connector according to claim 1, wherein the shutoff valve is rotated in response to the adjustment member being turned, thereby opening or closing a fluid passage.

3. The multi-purpose connector according to claim 2, wherein the fastening portions comprise male threads provided on the both ends of the body.

4. The multi-purpose connector according to claim 2, wherein the fastening portions comprise a male thread provided on one end of the both ends of the body and a female thread provided on the other end of the both ends of the body.

5. The multi-purpose connector according to claim 4, wherein a portion of the body, including the female thread of the fastening portions, comprises a reducer to which the sprinkler head is directly coupled.

6. The multi-purpose connector according to claim 3, wherein a first male thread of the male threads is connected to the sprinkler pipe, a reducer is connected to a second male thread of the male threads, and the sprinkler head is connected to the reducer.

7. The multi-purpose connector according to claim 1, wherein the shutoff valve comprises a ball valve or a butterfly valve.

8. The multi-purpose connector according to claim 1, wherein the adjustment member comprises a lever connected to and protruding from a stem of the shutoff valve.

9. The multi-purpose connector according to claim 1, wherein the adjustment member is connected to a stem of the shutoff valve, and has a jig groove, thereby allowing the adjustment member be manipulated using a jig.

10. The multi-purpose connector according to claim 8, wherein the shutoff valve is completely opened when the lever is aligned with a centerline of the body and is completely closed when the lever is at right angles with respect to the centerline of the body.

11. The multi-purpose connector according to claim 8, wherein the lever is coated with a luminous material.

12. A multi-purpose connector module for a sprinkler, comprising:
a multi-purpose connector comprising a body, fastening portions provided on both ends of the body, a shutoff valve disposed within the body, and an adjustment member disposed outside of the body to control the shutoff valve;
a sprinkler head connected to the fastening portion on one end of the both ends of the body;
a flexible sprinkler pipe, with a bottom end thereof being connected to the fastening portion on the other end of the both ends of the body using a slip nut; and
a nipple connected to and branched from a fire suppression branch pipe, wherein a top end of the flexible sprinkler pipe is connected to the nipple using a slip nut.
